(19) United States
(12) Patent Application Publication
(10) Pub. No.: US 2005/0034633 A1
(43) Pub. Date: Feb. 17, 2005

(54) Flux compositions for sintering Ni-Zn ferrite material

(75) Inventor: Yuan-Ho Lai, Hsinchu Hsien (TW)

Correspondence Address: NIKOLAI & MERSEREAU, P.A., 900 SECOND AVENUE SOUTH, SUITE 820, MINNEAPOLIS, MN, 55402, US

(73) Assignee: CHILISIN ELECTRONICS CORP., Hsinchu Hsien (TW)

(21) Appl. No.: 10/914,314

(22) Filed: Aug. 9, 2004

(30) Foreign Application Priority Data
Aug. 12, 2003 (TW) 092122151

(51) Int. Cl. C09K 3/00; C04B 35/00

(52) U.S. Cl. 106/313

(57) ABSTRACT

Flux compositions for sintering Ni—Zn ferrite material are disclosed in the present invention, each flux composition basically and selectively has zinc oxide (ZnO), silicon dioxide (SiO₂), boric oxide (B₂O₃), bismuth trioxide (Bi₂O₃), aluminum oxide (Al₂O₃), potassium trioxide (K₂O₃), barium oxide (BaO), sodium oxide (Na₂O), calcium oxide (CaO), and magnesium oxide (MgO). Each flux composition is added into a mixture of Ni—Zn ferrite material composed of ferric oxide (Fe₂O₃), nickel oxide (NiO), zinc oxide (ZnO), cupric oxide (CuO) and cobalt oxide (CoO) and ranges from 0.05 to 10 weight percent based on the total weight of the Ni—Zn ferrite material. The flux compositions of the present invention decrease sintering temperature when the ferrite material is sintered and contain no lead (Pb) element so as to reduce toxic pollutants.

### 1. FIELD OF THE INVENTION

The present invention relates to flux compositions for sintering Ni—Zn ferrite material, and more particularly to flux compositions that contain no pollutant lead element and efficiently decrease sintering temperature of the Ni—Zn ferrite material.

### 2. DESCRIPTION OF RELATED ART

Ferrite material containing Ni—Zn elements is widely applied in manufacturing iron core of Chip-type inductance device and basically comprises ferric oxide (Fe₂O₃), nickel oxide (NiO), zinc oxide (ZnO), cupric oxide (CuO) and cobalt oxide (CoO) compounds in powder forms. Mixture of these compounds is sintered at high temperature to obtain the Ni—Zn ferrite material. According to concerns of equipment limitations and manufacturing costs, an additive such as lead oxide (PbO) adds into the mixture to reduce the sintering temperature. Preferred composition of the mixture and the additive of lead oxide is composed of: 55 to 75 weight percent of ferric oxide, 3 to 22 weight percent of nickel oxide, 5 to 22 weight percent of zinc oxide, 1 to 8 weight percent of cupric oxide, 0.1 to 3 weight percent of cobalt oxide and 1.5 to 8 weight percent of lead oxide. The weight percents of all compounds are based on the total weight of the mixture and the additive. The sintering temperature of the ferrite material is decreased from 1200. degree. to 900.degree. C. with reference to FIG. 1, a curve diagram shows the relation between quantity percent of lead oxide and the sintering temperature is shown.

However, environmental protections become a mainstream issue in every country, toxic material is strictly forbidden in industrial manufacturing. The additive of lead oxide is a toxic material that is harmful to human body and causes environment pollutions. Therefore, developing a new lead-free additive (served as a flux), which causes no environment pollutions but maintains effective electric property in the ferrite material, is an important subject for related manufacturers.

The present invention provides a flux composition to mitigate or obviate the disadvantages of the conventional lead-containing additive.

### SUMMARY OF THE INVENTION

The first objective of the present invention is to provide flux compositions for sintering Ni—Zn ferrite material, which are lead-free and cause no pollutions to the environment.

The second objective of the present invention is to provide flux compositions for sintering Ni—Zn ferrite material, which lower sintering temperature in manufacturing processes and maintain effective electric properties in the achieved Ni—Zn ferrite material.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention and the detailed description of the preferred embodiment in addition to the scope of the invention defined by the claims taken in conjunction with the accompanying drawings.

### BRIEF DESCRIPTION OF THE DRAWINGS

FIG. 1 is a corresponding curve graph of conventional additive of lead oxide in relation to sintering temperatures;

FIG. 2 is a corresponding curve graph of a first flux composition which shows relation between the quantity variations of the first flux composition and the sintering temperatures;

FIG. 3 is a corresponding curve graph of a second flux composition which shows relation between the quantity of the second flux composition and the sintering temperatures;

FIG. 4 is a corresponding curve graph of a third flux composition which shows relation between the quantity of the third flux composition and the sintering temperatures;

FIG. 5 is a corresponding curve graph of a fourth flux composition which shows relation between the quantity of the fourth flux composition and the sintering temperatures;

FIG. 6 is a corresponding curve graph of a fifth flux composition which shows relation between the quantity of the fifth flux composition and the sintering temperatures;

FIG. 7 is a corresponding curve graph of a sixth flux composition which 18 shows relation between the quantity of the sixth flux composition and the sintering temperatures;

FIG. 8 is a corresponding curve graph of a seventh flux composition which shows relation between the quantity of the seventh flux composition and the sintering temperatures; and

FIG. 9 is a corresponding curve graph of an eighth flux composition which shows relation between the quantity of the eighth flux composition and the sintering temperatures.

### DETAILED DESCRIPTION OF THE PREFERRED EMBODIMENT

Flux compositions for sintering Ni—Zn ferrite material in accordance with the present invention, each flux composition basically and selectively comprises zinc oxide (ZnO), silicon dioxide (SiO₂), boric oxide (B₂O₃), bismuth trioxide (Bi₂O₃), aluminum oxide (Al₂O₃), potassium trioxide (K₂O₃), barium oxide (BaO), sodium oxide (Na₂O), calcium oxide (CaO), and magnesium oxide (MgO). Each flux composition is added into a mixture of Ni—Zn ferrite material composed of ferric oxide (Fe₂O₃), nickel oxide (NiO), zinc oxide (ZnO), cupric oxide (CuO) and cobalt oxide (CoO) and ranges from 0.05 to 10 weight percent based on the total weight of ferrite material. The flux compositions of the present invention decrease sintering temperature when the Ni—Zn ferrite material is sintered contain no lead element to reduce toxic pollutants.

Preferably, each flux composition has a main component and at least one additive. The main component is selected from the group consisting of sodium oxide (Na₂O), silicon dioxide (SiO₂), bismuth oxide (Bi₂O₃), and a mixture of silicon dioxide (SiO₂) and boric oxide (B₂O₃). The at least one additive is optionally selected from the group consisting of zinc oxide (ZnO), aluminum oxide (Al₂O₃), sodium oxide (Na₂O), magnesium oxide (MgO), boric oxide (B₂O₃), silicon dioxide (SiO₂), potassium trioxide (K₂O₃), barium oxide (BaO), calcium oxide (CaO) and mixture thereof. The at least one additive is selected from above materials different to the main component and various in different combinations according to the main component. Some preferred embodiments of the flux compositions are shown in the following.

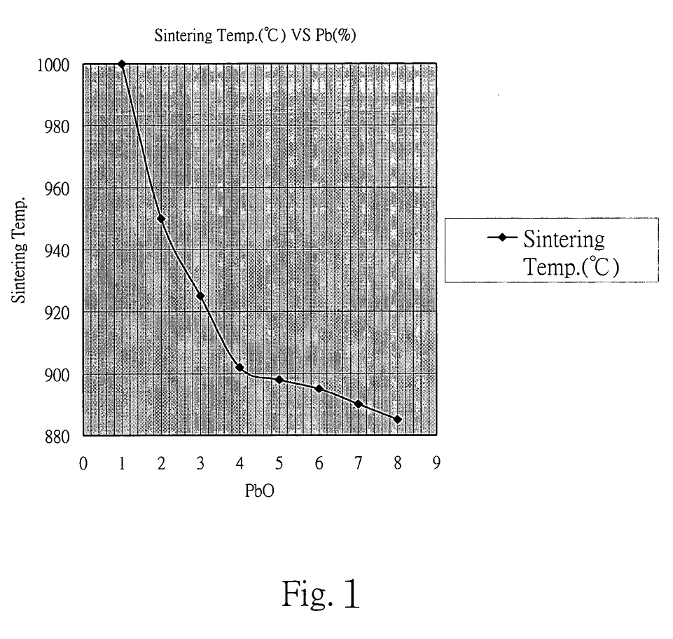

With reference to FIG. 1, a graph shows relation of quantity percent of a conventional flux for sintering ferrite material containing lead and sintering temperatures. The drawbacks of the conventional flux containing lead have mentioned above and redundant description of the drawbacks is obviated here.

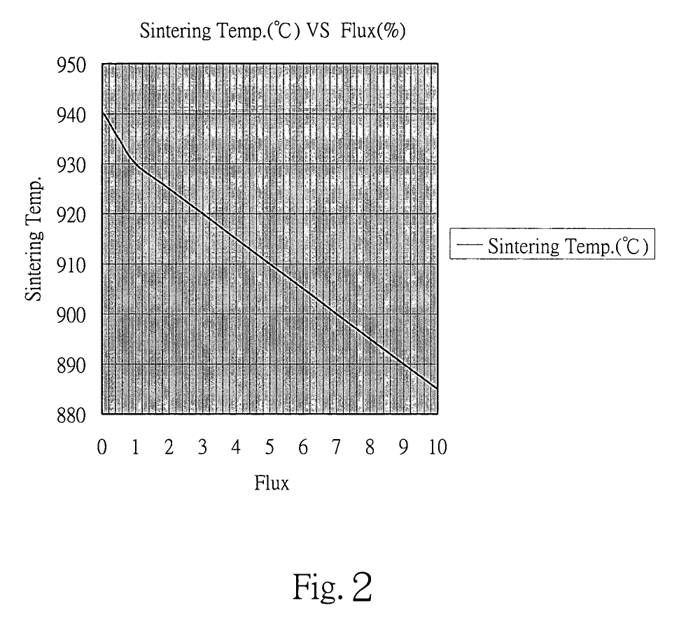

FIG. 2 shows relation between the quantity percent of a first flux composition of the present invention and the sintering temperatures. The first flux composition is composed of silicon oxide (SiO₂, 40 to 70 w/w %), boric oxide (B₂O₃, 5 to 30 w/w %) and zinc oxide (ZnO, 5 to 30% w/w %). The first flux composition ranges from 0.05 to 10 weight percent based on weight of the ferrite material and significantly decrease the sintering temperature from 1200. degree. C. to 885. degree. C. (about 315 degree. C differential lowered).

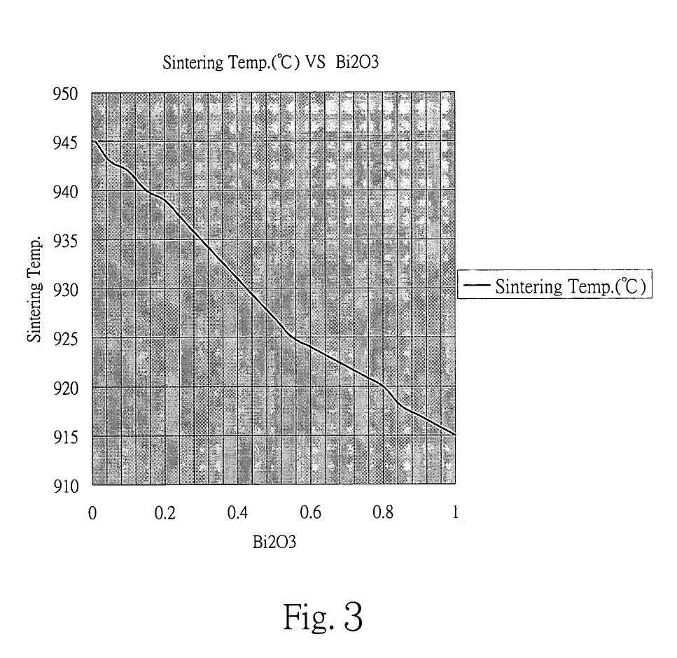

FIG. 3 shows relation between the quantity percent of a second flux composition of the present invention and the sintering temperatures. The second flux composition mainly contains bismuth trioxide (Bi₂O₃) and is of 0.05 to 5 weight percent added into the Ni—Zn ferrite material to reduce the sintering temperature from 1200. degree. C. to 915. degree. C. (about 285. degree. C differential lowered).

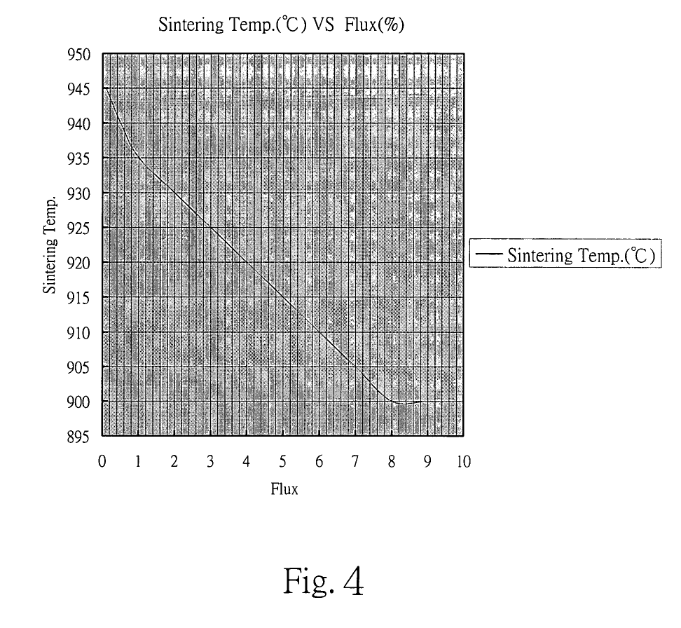

FIG. 4 shows relation between the quantity percent of a third flux composition of the present invention and the sintering temperatures. The third flux composition is composed of silicon dioxide (SiO₂, 55 to 70 w/w %), boric oxide (B₂O₃, 10 to 25 w/w %) and aluminum oxide (Al₂O₃, 5 to 20% w/w %). The third flux composition ranges from 0.05 to 10 weight percent based on weight of the ferrite material and significantly decreases the sintering temperature from 945 degree. C. to 900. degree. C. (about 45 degree. C. differential lowered).

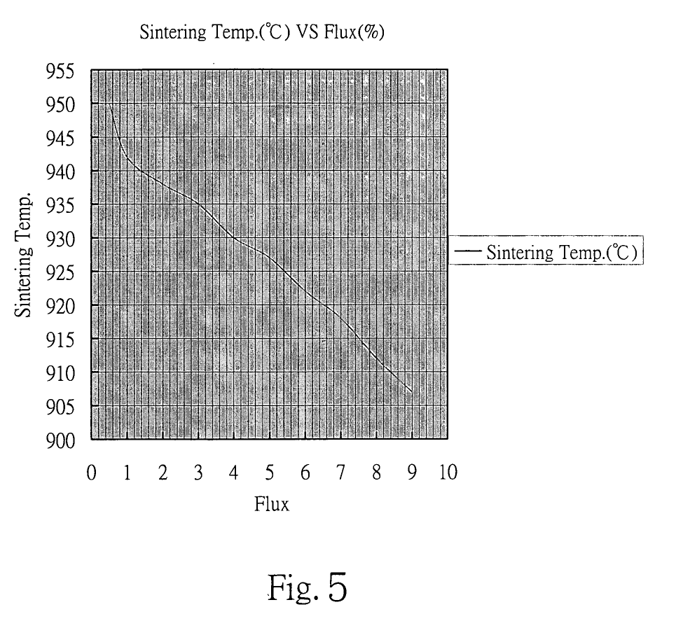

FIG. 5 shows between of the quantity percent of a fourth flux composition of the present invention and the sintering temperatures. The fourth flux composition is composed of silicon dioxide (SiO₂, 55 to 70 w/w %), potassium trioxide (K₂O₃, 5 to 10 w/w %), barium oxide (BaO, 10 to 25 w/w %) and sodium oxide (Na₂O, 5 to 10 w/w %). The fourth flux composition ranges from 0.05 to 10 weight percent based on weight of the ferrite material and significantly decreases the sintering temperature from 1200. degree. C. to 907. degree. C. (about 293. degree C. differential lowered).

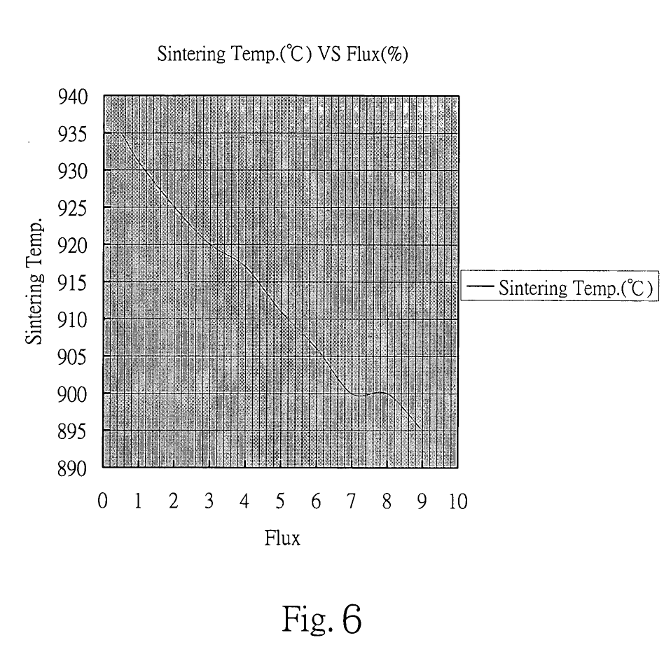

FIG. 6 shows relation between the quantity percent of a fifth flux composition of the present invention and the sintering temperatures. The fifth flux composition is composed of silicon dioxide (SiO₂, 55 to 70 w/w %), boric oxide (B₂O₃, 10 to 25 w/w %) and sodium oxide (Na₂O, 5 to 20% w/w %). The fifth flux composition ranges from 0.05 to 10 weight percent based on weight of the ferrite material and significantly decreases the sintering temperature from 1200. degree. C. to 895. degree. C. (about 305. degree C. differential lowered).

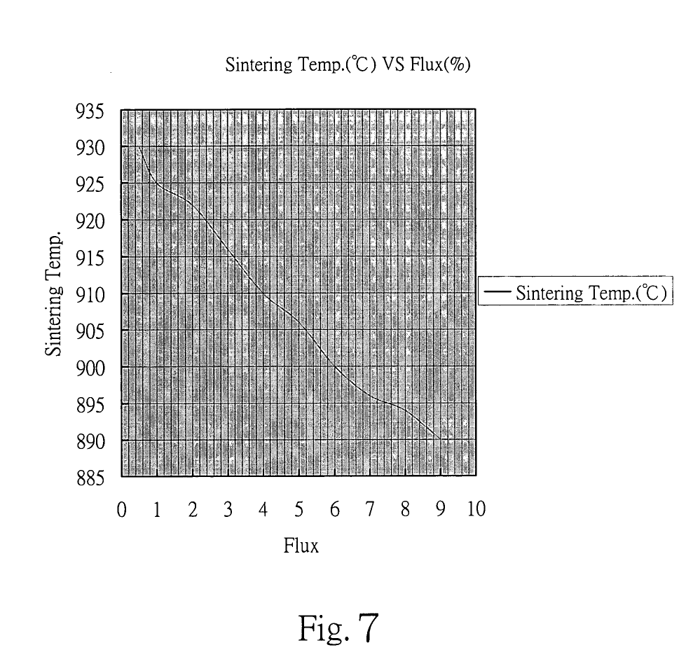

FIG. 7 shows between of the quantity percent of a sixth flux composition of the present invention and the sintering temperatures. The sixth flux composition is composed of zinc dioxide (ZnO, 55 to 70 w/w %), boric oxide (B₂O₃, 10 to 25 w/w %) and Sodium oxide (Na₂O, 5 to 20% w/w %). The sixth flux composition ranges from 0.05 to 10 weight percent based on weight of the ferrite material and significantly decreases the sintering temperature from 1200. degree. C. to 890. degree. C. (above 210. degree C. differential lowered).

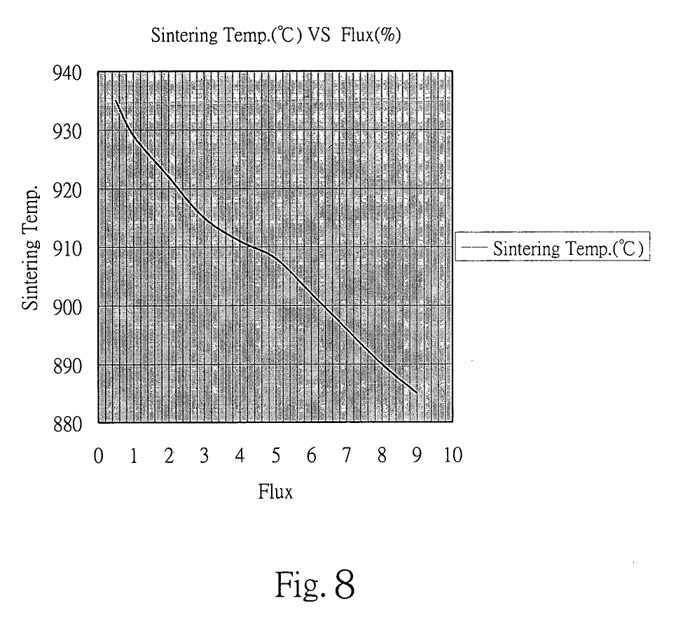

FIG. 8 shows relation between the quantity percent of a seventh flux composition of the present invention and the sintering temperatures. The seventh flux composition is composed of silicon dioxide (SiO₂, 55 to 70 w/w %), barium oxide (BaO, 10 to 25 w/w %) and calcium oxide (CaO, 5 to 20% w/w %). The seventh flux composition ranges from 0.05 to 10 weight percent based on weight of the ferrite material and significantly decreases the sintering temperature from 1200. degree. C. to 885. degree. C. (about 315. degree. C. differential lowered).

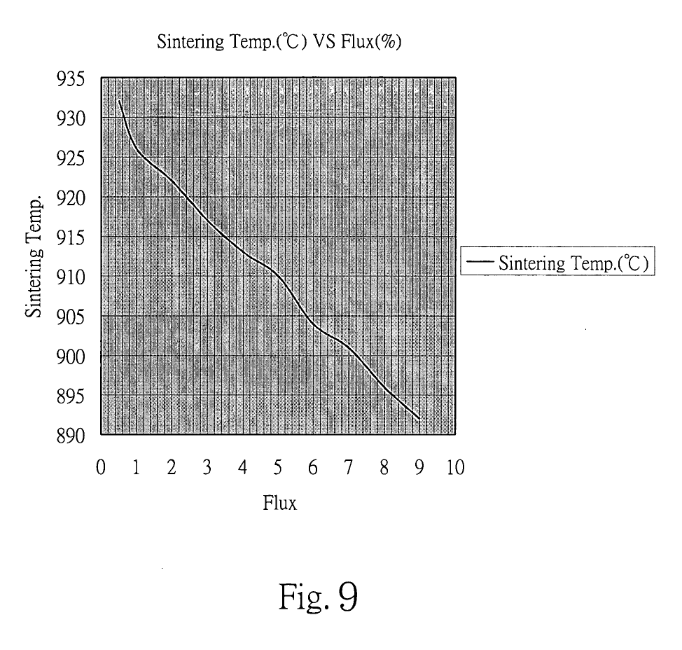

FIG. 9 shows relation between the quantity percent of an eighth flux composition of the present invention and the sintering temperatures. The eighth flux composition is composed of silicon dioxide (SiO₂, 55 to 70 w/w %), boric oxide (B₂O₃, 10 to 25 w/w %) and magnesium oxide (MgO, 5 to 20% w/w %). The eighth flux composition ranges from 0.05 to 10 weight percent based on weight of the ferrite material and significantly decreases the sintering temperature from 1200. degree. C. to 892. degree. C. (about 308. degree. C. differential lowered).

According to above description of graphs from experiments, the flux compositions in the present invention actually and greatly decrease the sintering temperatures of the Ni—Zn ferrite material and are adapted to substitute the conventional lead-containing flux composition in the prior art.

The present invention includes that contained in the appended claims, as well as that of the foregoing description. Although this invention has been described in its preferred embodiments with a certain degree of particularity, it is understood that the present invention of the preferred form has been made only by way of example and that numerous changes in the details of construction and the combination and arrangement of parts any be resorted to without departing from the spirit and scope of the invention.

1. A flux composition for sintering Ni—Zn ferrite material comprising:
silicon dioxide (SiO₂);
boric oxide (B₂O₃); and
an additive;
wherein, the flux composition ranges from 0.05 to 10 weight percent based on a total weight of the Ni—Zn ferrite material.

2. The flux composition as claimed in claim 1, wherein the additive is zinc oxide (ZnO).

3. The flux composition as claimed in claim 2, wherein the flux composition is of:
silicon dioxide (SiO₂): 40 to 70 weight percent;
boric oxide (B₂O₃): 5 to 30 weight percent; and
zinc oxide (ZnO): 5 to 30 weight percent.

4. The flux composition as claimed in claim 1, wherein the additive is aluminum oxide (Al₂O₃).

5. The flux composition as claimed in claim 4, wherein the flux composition is of:
silicon dioxide (SiO₂): 40 to 70 weight percent;
boric oxide (B₂O₃): 5 to 30 weight percent; and
aluminum oxide (Al₂O₃): 5 to 20 weight percent.

6. The flux composition as claimed in claim 1, wherein the additive is sodium oxide (Na₂O).

7. The flux composition as claimed in claim 6, wherein the flux composition is of:
silicon dioxide (SiO₂): 40 to 70 weight percent;
boric oxide (B₂O₃): 5 to 30 weight percent; and
sodium oxide (Na₂O): 5 to 20 weight percent.

8. The flux composition as claimed in claim 1, wherein the additive is magnesium oxide (MgO).

9. The flux composition as claimed in claim 8, wherein the flux composition is of:
silicon dioxide (SiO₂): 40 to 70 weight percent;
boric oxide (B₂O₃): 5 to 30 weight percent; and
magnesium oxide (MgO): 5 to 20 weight percent.

10. A flux composition for Ni—Zn sintering material comprising:
sodium oxide (Na₂O); and
at least two additives;
wherein, the flux composition ranges from 0.05 to 10 weight percent based on a total weight of the Ni—Zn ferrite material.

11. The flux composition as claimed in claim 10, wherein two additives are in the flux composition and are respectively zinc oxide (ZnO) and boric oxide (B₂O₃).

12. The flux composition as claimed in claim 11, wherein the flux composition is of:
sodium oxide (Na₂O): 5 to 20 weight percent;
zinc oxide (ZnO): 55 to 70 weight percent; and
boric oxide (B₂O₃): 10 to 25 weight percent.

13. The flux composition as claimed in claim 10, wherein three additives are in the flux composition and are respectively silicon dioxide (SiO₂), potassium trioxide (K₂O₃) and barium oxide (BaO).

14. The flux composition as claimed in claim 13, wherein the flux composition is of:
sodium oxide (Na₂O): 5 to 10 weight percent;
silicon dioxide (SiO₂): 55 to 70 weight percent;
potassium trioxide (K₂O₃): 5 to 10 weight percent; and
barium oxide (BaO): 10 to 25 weight percent.

15. A flux composition for sintering Ni—Zn ferrite material comprising:
silicon dioxide (SiO₂); and
at least two additives;
wherein, the flux composition ranges from 0.05 to 10 weight percent based on a total weight of the Ni—Zn ferrite material.

16. The flux composition as claimed in claim 15, wherein two additives are in the flux composition and are respectively barium oxide (BaO) and calcium oxide (CaO).

17. The flux composition as claimed in claim 16, wherein the flux composition is of:
silicon dioxide (SiO₂): 55 to 70 weight percent;
barium oxide (BaO): 10 to 25 weight percent; and
calcium oxide (CaO): 5 to 20 weight percent.

18. A flux composition for Ni—Zn sintering material comprising:
bismuth trioxide (Bi₂O₃); and
at least one additive;
wherein, the flux composition ranges from 0.05 to 10 weight percent based on a total weight of the Ni—Zn ferrite material.
